(19) United States
(12) Patent Application Publication
(10) Pub. No.: US 2012/0084919 A1
(43) Pub. Date: Apr. 12, 2012

(54) PATIENT POSITIONING APPARATUS

(75) Inventors: William K McCroskey, Solon, OH (US); Ethan Kay, Auburn, OH (US)

(73) Assignee: FMI TECHNOLOGIES, INC., Akron, OH (US)

(21) Appl. No.: 13/269,607

(22) Filed: Oct. 9, 2011

Related U.S. Application Data
(60) Provisional application No. 61/391,624, filed on Oct. 9, 2010.

(51) Int. Cl. A61G 13/08; A61G 13/06

(52) U.S. Cl. 5/601

(57) ABSTRACT

A patient positioning apparatus for supporting and properly positioning a patient during medical imaging procedures. A positioning apparatus can be segmented into articulated sectional members, which may be pivotally connected to one another allowing proper positioning within the gantry port of a CT, PET, and/or SPECT tomography scanning machine.

### I. CROSS REFERENCE TO RELATED APPLICATIONS

This invention claims priority to U.S. Provisional Patent Application No. 61/391,624 filed Oct. 9, 2010 and now pending, and which is incorporated by reference in its entirety.

### II. BACKGROUND OF THE INVENTION

A. Field of Invention

This invention generally relates to apparatuses for patient positioning during computed tomography (CT), positron emission tomography (PET), and/or single photon emission computed tomography (SPECT).

B. Description of the Related Art

In the field of medical tomography imaging, proper placement of the patient during scanning is important to obtaining proper images. Furthermore, tomography scanning can take several minutes or longer. Comfort of the patient during this time is very important due to the fact that a patient must remain still in order to obtain suitable results. Movement by the patient during the procedure can result in unusable image data, and consumption of additional instrument and professional time. Thus, faulty patient positioning can increase the cost of the medical imaging procedure.

What is needed is an apparatus for proper and comfortable positioning of a patient during the imaging process. Some embodiments of the present invention overcome one or more limitations of the prior art.

### III. SUMMARY OF THE INVENTION

Some embodiments relate to a patient positioning apparatus, comprising: a patient support surface including a plurality of generally planar segments joined end-to-end in a hinged relation; a vertical support defining a generally elongate structure having a first end and a second end, the first end supportively engaging a portion of the patient support surface; a translational motion means engaging the second end of the vertical support and adapted to translate the patient support surface in a linear direction along an axis generally perpendicular to a patient aperture of a medical imaging device; a base engaging the translational motion means in a supportive fixed relation; a mechanical coupling disposed in a fixed relation at an end of the base, and adapted to mechanically engage a medical imaging instrument in a fixed relation; and an electronic coupling disposed at an end of the base, and adapted to electrically engage the medical imaging instrument.

According to some embodiments each generally planar segment includes a support surface defining shapes selected from one or more of generally planar, flat, rounded, or contoured.

According to some embodiments the hinged relation between adjacent segments of the patient support surface includes a motorized hinged relation and/or a manual hinged relation.

According to some embodiments the hinged relation further comprises a means for fixing the position of a segment including one or more of a mechanical stop, an index pin, and/or a clamp.

According to some embodiments the vertical support comprises a lift system.

According to some embodiments the translational motion means comprises one or more of a lead screw, a ball screw, a servomechanism, a linear bearing, a rail, a track, and/or a belt drive.

According to some embodiments the electronic coupling comprises one or more of a control bus, a data bus, an address bus, and/or a power bus.

A patient positioning apparatus, comprising: a patient support surface including a plurality of generally planar segments joined end-to-end in a hinged relation, wherein each generally planar segment includes a support surface defining shapes selected from one or more of generally planar, flat, rounded, or contoured, and wherein the hinged relation between adjacent segments of the patient support surface includes a motorized hinged relation and/or a manual hinged relation; a vertical support defining a generally elongate structure having a first end and a second end, the first end supportively engaging a portion of the patient support surface, wherein the vertical support comprises a lift system; a translational motion means engaging the second end of the vertical support and adapted to translate the patient support surface in a linear direction along an axis generally perpendicular to a patient aperture of a medical imaging device, wherein the translational motion means comprises one or more of a lead screw, a ball screw, a servomechanism, a linear bearing, a rail, a track, and/or a belt drive; a base engaging the translational motion means in a supportive fixed relation; a mechanical coupling disposed in a fixed relation at an end of the base, and adapted to mechanically engage a medical imaging instrument in a fixed relation; and an electronic coupling disposed at an end of the base, and adapted to electrically engage the medical imaging instrument, wherein the electronic coupling comprises one or more of a control bus, a data bus, an address bus, and/or a power bus.

According to some embodiments the hinged relation further comprises a means for fixing the position of a segment including one or more of a mechanical stop, an index pin, and/or a clamp.

A patient positioning apparatus, comprising: a patient support surface including one or more generally planar support surfaces adapted to supportively engage a patient; a vertical support defining a generally elongate structure having a first end and a second end, the first end supportively engaging a portion of the patient support surface; a translational motion means engaging the second end of the vertical support and adapted to translate the patient support surface in a linear direction along an axis generally perpendicular to a patient aperture of a medical imaging device; a base engaging the translational motion means in a supportive fixed relation; and a docking system adapted to mechanically and/or electronically link with a medical imaging device.

According to some embodiments the one or more generally planar support surfaces comprises a single support surface.

According to some embodiments the one or more generally planar support surfaces comprises a plurality of segments joined end-to-end in a hinged relation.

According to some embodiments each segment includes a support surface defining shapes selected from one or more of generally planar, flat, rounded, or contoured.

According to some embodiments the hinged relation between adjacent segments of the patient support surface includes a motorized hinged relation and/or a manual hinged relation.

According to some embodiments the translational motion means comprises one or more of a lead screw, a ball screw, a servomechanism, a linear bearing, a rail, a track, and/or a belt drive.

According to some embodiments the docking system further comprises a mechanical coupling disposed in a fixed relation at an end of the base, and adapted to mechanically engage a medical imaging instrument in a fixed relation.

According to some embodiments the docking system further comprises an electronic coupling disposed at an end of the base, and adapted to electrically engage the medical imaging instrument.

According to some embodiments the electronic coupling comprises one or more of a control bus, a data bus, an address bus, and/or a power bus.

Other benefits and advantages will become apparent to those skilled in the art to which it pertains upon reading and understanding of the following detailed specification.

### IV. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a patient positioning apparatus; and

FIG. 2 is a perspective view of a patient positioning and a tomography scanning machine.

### V. DETAILED DESCRIPTION OF THE INVENTION

According to some embodiments, a patient positioning apparatus comprises a segmented patient support surface. The segments can be pivotally connected to one another in a hinged relation. The apparatus can include a vertical support structure joined at one end to the patient support surface, and also joined at an opposing end to base including a translational motion means. The translational motion means can be adapted to translate the segmented patient support surface in a linear direction. In some embodiments, the apparatus includes a docking system adapted to mechanically and/or electronically link the apparatus to a tomographic imaging system in a generally fixed relation. Furthermore, in some embodiments a mechanical coupling can additionally function as or include an electronic connection for automatically controlling the patient support surface. Thus, a computer for controlling the patient support surface can be located remotely, such as onboard the tomographic imaging system.

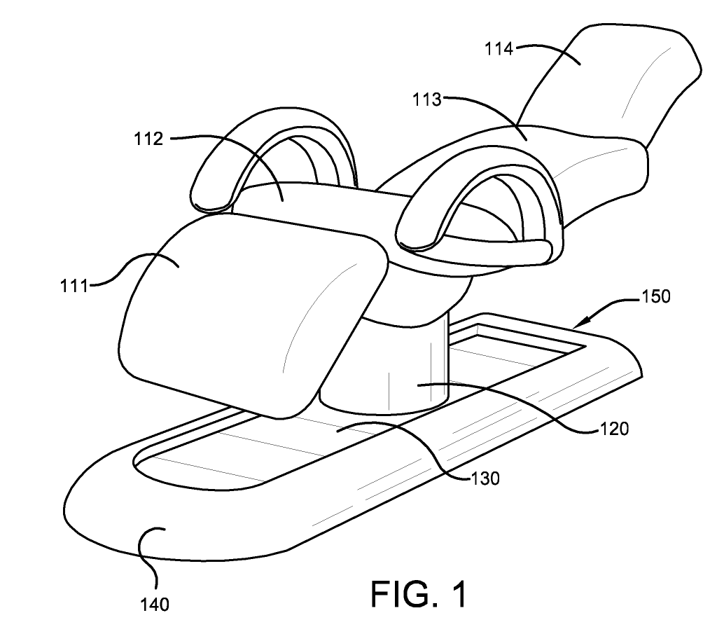

With reference to FIG. 1, according to an embodiment 100, a patient support surface can be segmented into a first section 111, a second section 112, a third section 113, and a fourth section 114, each section defining generally rectangular shape(s). Although this example sets forth four segments, embodiments can include one, two, three, four, five or any suitable number of segments. According to embodiments having a plurality of patient support segments, the segments can be arranged end-to-end in a hinged relation. For example, the first section 111, can be disposed at a foot-end of the patient support surface, and can be pivotally joined to the second section 112 in a hinged relationship. The second section 112 defines a seat region of the patient support surface and can be pivotally joined to the third section 113 in a hinged relationship at a side opposing the first section 111. Similarly, the third section 113 defines a back region and can be joined in a hinged relation with a fourth section 114 at a side opposing the second section 112. The fourth section 114 defines a back and/or head region.

In some embodiments the sections 111, 112, 113, 114 can be joined in a hinged relation including a means for positioning and/or locking the segments in a selected configuration. For instance, a hinged relation can include mechanical stops, an indexed pin-and-hole, a clamp, or any of a wide variety of suitable position-fixing means known in the art. Furthermore, a hinged relation can include a motorized hinged relation, wherein segment positioning can be under electronic control.

Although the description herein focuses on segments having a generally rectangular shape, one of skill in the art will recognize that any of a wide variety of shapes can be suitable. Furthermore, one or more segments may include support surfaces that contact a patient which include contours adapted to receive portions of a patient's body in a supportive relation. Such contours may be suitable for accurately and comfortably positioning a patient. Some embodiments may thus include pre-formed contoured surfaces, or form-fitting cushions, such as a memory foam, for adapting to the shape of each individual patient's body. As used herein when referring to patient support segments, the term generally planar shape includes surfaces that are flat, rounded, and/or include contours as described hereinabove.

According to some embodiments, a vertical support 120 defines an elongated structure having one end joined to a motorized translational motion means 130 and having an opposing end pivotally connected to one or more segments of the patient support surface as shown in FIG. 1. In some embodiments a joint connecting a vertical support 120 with a segment(s) can be adapted to rotate about one or more axes. The joint can additionally be motorized for positioning the patient support surface in a desired orientation.

With specific regard to the vertical support 120, such support can comprise any of a variety of suitable structures including without limitation, a single post as shown in FIG. 1, or a plurality of posts. For instance, each segment may have a separate vertical support. Additionally, some embodiments can also comprise one or more rails supporting the segments 111, 112, 113, 114 in a fixed or slidable relation. Furthermore, in some embodiments a vertical support 120 can comprise a lift such as, without limitation, a hydraulic and/or telescoping lift system.

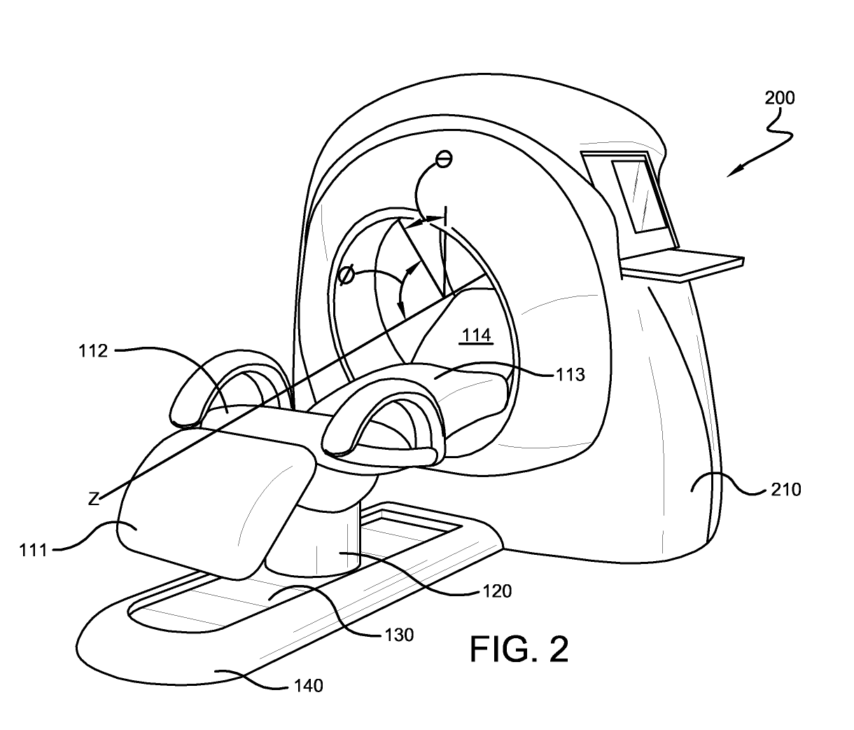

According to some embodiments 200, a translational motion means 130 is adapted to translate in a linear direction substantially perpendicular to a gantry port 100 of an imaging device as shown in FIG. 2, i.e. along a z-axis. A motorized translational motion means 130 enables automatic positioning of a patient for scanning as shown in FIG. 3. Suitable translational motion means can comprise any of a wide variety of linear drive systems known in the art including, without limitation, lead screws, ball screws, servomechanisms, linear bearing systems, rails, tracks, and/or belt drive systems.

As illustrated in FIG. 2, some embodiments can include a base 140 that contains, partially encloses, and/or supports the translational motion means 130. In some embodiments a base 140 can include a docking means 150 for mechanically and/or electronically linking a patient support apparatus 100 to a medical imaging device 210. Suitable docking means 150 can engage a medical imaging system 210 in a fixed relation, which may be reversible or permanent. For instance, in some embodiments the patient support apparatus 100 can be adapted to be engaged and disengaged from the medical imaging system 210 as needed. Suitable docking means 150 can take any of a wide variety of forms including without limitation, mechanical couplings and/or magnetic couplings. Furthermore, in some embodiments, the docking means 150 also includes an electronic coupling including one or more of a control bus, data bus, address bus, and/or power bus. In some embodiments the docking means 150 can include a single coupling performing the duel function of a mechanical and an electronic coupling; however, in other embodiments, separate mechanical and/or electronic couplings may be included.

Embodiments have been described hereinabove and shown in the various drawing views, which are included for purposes of illustration and not for limiting the same. Thus, it will be apparent to those skilled in the art that the above methods and apparatuses may incorporate changes and modifications without departing from the general scope of the invention. Accordingly, the invention is intended to include all such modifications and alterations insofar as they come within the scope of the appended claims or the equivalents thereof.

Having thus described the invention, it is now claimed:

I/we claim:

1. A patient positioning apparatus, comprising:
a patient support surface including a plurality of generally planar segments joined end-to-end in a hinged relation;
a vertical support defining a generally elongate structure having a first end and a second end, the first end supportively engaging a portion of the patient support surface;
a translational motion means engaging the second end of the vertical support and adapted to translate the patient support surface in a linear direction along an axis generally perpendicular to a patient aperture of a medical imaging device;
a base engaging the translational motion means in a supportive fixed relation;
a mechanical coupling disposed in a fixed relation at an end of the base, and adapted to mechanically engage a medical imaging instrument in a fixed relation; and
an electronic coupling disposed at an end of the base, and adapted to electrically engage the medical imaging instrument.

2. The apparatus of claim 1, wherein each generally planar segment includes a support surface defining shapes selected from one or more of generally planar, flat, rounded, or contoured.

3. The apparatus of claim 1, wherein the hinged relation between adjacent segments of the patient support surface includes a motorized hinged relation and/or a manual hinged relation.

4. The apparatus of claim 3, wherein the hinged relation further comprises a means for fixing the position of a segment including one or more of a mechanical stop, an index pin, and/or a clamp.

5. The apparatus of claim 1, wherein the vertical support comprises a lift system.

6. The apparatus of claim 1, wherein the translational motion means comprises one or more of a lead screw, a ball screw, a servomechanism, a linear bearing, a rail, a track, and/or a belt drive.

7. The apparatus of claim 1, wherein the electronic coupling comprises one or more of a control bus, a data bus, an address bus, and/or a power bus.

8. A patient positioning apparatus, comprising:
a patient support surface including a plurality of generally planar segments joined end-to-end in a hinged relation, wherein each generally planar segment includes a support surface defining shapes selected from one or more of generally planar, flat, rounded, or contoured, and wherein the hinged relation between adjacent segments of the patient support surface includes a motorized hinged relation and/or a manual hinged relation;
a vertical support defining a generally elongate structure having a first end and a second end, the first end supportively engaging a portion of the patient support surface, wherein the vertical support comprises a lift system;
a translational motion means engaging the second end of the vertical support and adapted to translate the patient support surface in a linear direction along an axis generally perpendicular to a patient aperture of a medical imaging device, wherein the translational motion means comprises one or more of a lead screw, a ball screw, a servomechanism, a linear bearing, a rail, a track, and/or a belt drive;
a base engaging the translational motion means in a supportive fixed relation;
a mechanical coupling disposed in a fixed relation at an end of the base, and adapted to mechanically engage a medical imaging instrument in a fixed relation; and
an electronic coupling disposed at an end of the base, and adapted to electrically engage the medical imaging instrument, wherein the electronic coupling comprises one or more of a control bus, a data bus, an address bus, and/or a power bus.

9. The apparatus of claim 8, wherein the hinged relation further comprises a means for fixing the position of a segment including one or more of a mechanical stop, an index pin, and/or a clamp.

10. A patient positioning apparatus, comprising:
a patient support surface including one or more generally planar support surfaces adapted to supportively engage a patient;
a vertical support defining a generally elongate structure having a first end and a second end, the first end supportively engaging a portion of the patient support surface;
a translational motion means engaging the second end of the vertical support and adapted to translate the patient support surface in a linear direction along an axis generally perpendicular to a patient aperture of a medical imaging device;
a base engaging the translational motion means in a supportive fixed relation; and
a docking system adapted to mechanically and/or electronically link with a medical imaging device.

11. The apparatus of claim 10, wherein the one or more generally planar support surfaces comprises a single support surface.

12. The apparatus of claim 10, wherein the one or more generally planar support surfaces comprises a plurality of segments joined end-to-end in a hinged relation.

13. The apparatus of claim 12, wherein each segment includes a support surface defining shapes selected from one or more of generally planar, flat, rounded, or contoured.

14. The apparatus of claim 12, wherein the hinged relation between adjacent segments of the patient support surface includes a motorized hinged relation and/or a manual hinged relation.

15. The apparatus of claim 10, wherein the translational motion means comprises one or more of a lead screw, a ball screw, a servomechanism, a linear bearing, a rail, a track, and/or a belt drive.

16. The apparatus of claim 10, wherein the docking system further comprises a mechanical coupling disposed in a fixed relation at an end of the base, and adapted to mechanically engage a medical imaging instrument in a fixed relation.

17. The apparatus of claim 10, wherein the docking system further comprises an electronic coupling disposed at an end of the base, and adapted to electrically engage the medical imaging instrument.

18. The apparatus of claim 17, wherein the electronic coupling comprises one or more of a control bus, a data bus, an address bus, and/or a power bus.
